(19) United States
(12) Patent Application Publication
(10) Pub. No.: US 2026/0103938 A1
(43) Pub. Date: Apr. 16, 2026

(54) DOOR OPEN-CLOSE DEVICE FOR VEHICLE

(71) Applicants: Hyundai Motor Company, Seoul (KR); Kia Corporation, Seoul (KR); KWANGJIN CO., LTD., Asan-si (KR)

(72) Inventors: Jaeseung LEE, Hwaseong-Si (KR); Jin-Su JANG, Asan-Si (KR); Tae-Yong JEON, Pyeongtaek-Si (KR); Pil-Seong JEON, Asan-Si (KR); Jun-Yeong BAE, Asan-Si (KR)

(73) Assignees: Hyundai Motor Company, Seoul (KR); Kia Corporation, Seoul (KR); KWANGJIN CO., LTD., Asan-si (KR)

(21) Appl. No.: 19/233,847

(22) Filed: Jun. 10, 2025

(30) Foreign Application Priority Data
Oct. 16, 2024 (KR) 10-2024-0141354

(51) Int. Cl. E05F 15/63; E05D 15/30

(52) U.S. Cl. CPC E05F 15/63; E05D 15/30; E05F 2015/631; E05Y 2201/71; E05Y 2900/531

(57) ABSTRACT

A door open-close device for a vehicle configured to open or close a door opening portion by sliding and popping up a door disposed in a vehicle body includes a main arm motor fixedly disposed on a side of the vehicle body and configured to provide a driving power to operate the door, a main arm including one end portion hingedly coupled to the main arm motor and the other end portion hingedly coupled to the side of the door and configured to transmit a rotation force to the door by driving the main arm motor, and a variable sub-arm including one end portion hingedly coupled to the side of the vehicle body, including the other end portion hingedly coupled to the side of the door, and when the door is opened or closed, disposed to change a length thereof along a movement path of a rotation member which is disposed and rotated in one portion.

### CROSS-REFERENCE TO RELATED APPLICATION

The present application claims priority to Korean Patent Application No. 10-2024-0141354 filed with the Korean Intellectual Property Office on Oct. 16, 2024, the entire contents of which is incorporated herein for all purposes by this reference.

### BACKGROUND OF THE PRESENT DISCLOSURE

### Field of the Present Disclosure

The present disclosure relates to a door open-close device for a vehicle, and more particularly, to a bi-directional door open-close device for a vehicle configured to open or close a door opening portion of a vehicle body by sliding and popping up a door of the vehicle in both front and rear directions, in the vehicle without a B-pillar.

### Description of Related Art

In general, doors for a vehicle are doors that separate the interior and exterior of the vehicle, and serve an important function of protecting passengers safely by blocking external noise, rain, dust, and wind, etc and absorbing an impact along with a side structure in case of a side collision.

There are various types of doors for the vehicle, including doors for special purposes, but hinged swing doors are most often applied to passenger vehicles.

Usually, a swing door refers to a door that opens to the outside of a vehicle body around a hinge shaft installed through a hinge bracket between the vehicle body and the swing door, and has the advantage of being easy to open or close, and easy to maintain and repair due to a simple structure.

On the other hand, a counter-swing door that has a high sense of openness when a door is opened, and is advantageous for passengers to get on or off is applied to some vehicles. The counter-swing door is opened and closed by use of the rotation of an arm connected to the vehicle body and the door.

However, the counter swing door has the advantage of having a large amount of door opening and closing, but there is a problem of an excessive amount of protrusion to the outside of the vehicle when the door is opened due to a length of the arm. In addition, as shown in FIG. 1, a front door 2 connected to a vehicle body 1 by a front door arm 4 is popped up and swung to be opened first, and then a rear door 3 connected to a rear door arm 5 is popped up and swung to be opened, and when a door is closed, a process proceeds in reverse order. As described above, the order of opening and closing of front and rear doors is fixed, a manual operation is limited in case of emergency, and there is a possibility of collision between the front and rear doors during the manual operation. In addition, there are problems of sealing damage and jamming due to fixing the order of operations of the door.

### BRIEF SUMMARY

The present disclosure attempts to provide a door open-close device for a vehicle configured for improving operability, performance, and stability by applying a link of a variable length to a door, in a counter sliding door structure of the vehicle without a B-pillar.

A door open-close device for a vehicle configured to open or close a door opening portion by sliding and popping up a door disposed in a vehicle body according to an exemplary embodiment of the present disclosure includes a main arm motor fixedly disposed on a side of the vehicle body and configured to provide a driving power to operate the door, a main arm including one end portion hingedly coupled to the main arm motor and the other end portion hingedly coupled to the side of the door and configured to transmit a rotation force to the door by driving the main arm motor, and a variable sub-arm including one end portion hingedly coupled to the side of the vehicle body, including the other end portion hingedly coupled to the side of the door, and when the door is opened or closed, disposed to change a length thereof along a movement path of a rotation member which is disposed and rotated in one portion.

A main arm gear may be disposed in one end portion of the main arm, and engaged with a main arm motor gear formed on a rotation shaft of the main arm motor, so that the main arm is hingedly rotated when the main arm motor is driven.

The main arm may be formed in a curved shape toward an interior of the vehicle body.

The variable sub-arm may include a fixing sub-arm including one end portion hingedly coupled to the side of the vehicle body and a hollow formed therein, and a slide sub-arm slid and moved in a longitudinal direction of the fixing sub-arm so that one end portion thereof is moved relative to the fixing sub-arm, and the other end portion thereof is hingedly coupled to the side of the door.

The fixing sub-arm may be formed in a hollow shape extending in the longitudinal direction, and the slide sub-arm may operate to be inserted into or withdrawn from the hollow of the fixing sub-arm.

A guide bearing may be disposed in the slide sub-arm in one end portion as a rotation member that protrudes to rotate, and a first guide slit through which the guide bearing is disposed to penetrate and defining a sliding movement range of the slide sub-arm may be formed in the fixing sub-arm.

A base plate in which the main arm motor is fixedly disposed and to which one end portion of the main arm is hingedly coupled, and one end portion of the variable sub-arm is hingedly coupled, may be disposed on the side of the vehicle body.

A first guide slit providing a path varying a length of the variable sub-arm may be formed in the base plate as the guide bearing is inserted into the first guide slit and rotates.

The first guide slit may be is formed in a convex shape toward the side of the door.

A door bracket to which the other end portion of the main arm and the other end portion of the variable sub-arm are hingedly coupled and connecting the main arm and the variable sub-arm to the door may be disposed inside the door.

When opening of the door starts, the main arm motor may be driven to rotate one end portion of the main arm, and the variable sub-arm may be changed to shorten a length thereof so that overlapping between front and rear doors is prevented.

During opening of the door, after passing through an overlapping prevention period between the front and rear doors, the variable sub-arm may be changed to extend the length thereof.

The main arm motor may be set to stop driving when the door is completely opened.

The main arm motor may have a preset number of rotations to adjust a movement range of the main arm and an amount of opening of the door according to the number of rotations.

During a process of opening the door, an internal end portion of the door may move to have a similar movement path to a shape of the first guide slit.

According to an exemplary embodiment of the present disclosure, the variable door arm structure is applied in the counter sliding door structure of the vehicle without a B-pillar, and thus, the door rotation radius may minimized, minimizing the amount of protrusion toward the outside of the vehicle body of the door when the door is opened.

Furthermore, an interference avoidance operation between the front and rear doors is possible, which enables the door open-close operation regardless of the order of the front and rear doors, and sealing damage and jamming according to the order of door operations may be prevented.

Furthermore, a center rail structure is deleted, and thus, the door opening width may be maximized, and cost reduction, assembly, and maintainability may be improved due to the simplification of the structure.

### BRIEF DESCRIPTION OF THE DRAWINGS

FIG. 1 is a diagram schematically illustrating an opening operation process of the fixing link swing type door of the related art.

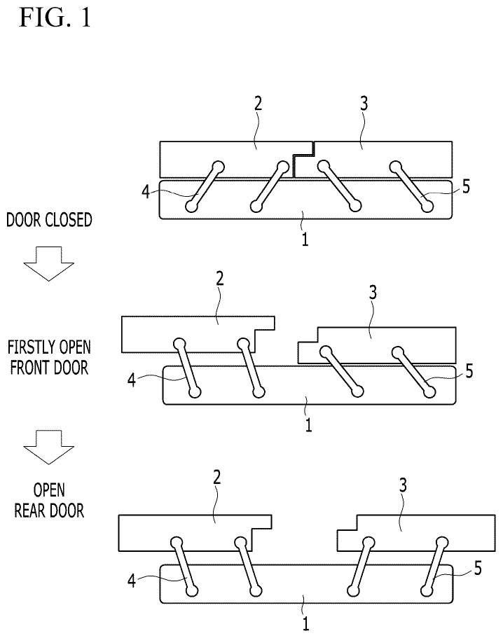

FIG. 2 is a diagram schematically illustrating a state in which a door open-close device for a vehicle according to an exemplary embodiment of the present disclosure is applied to the vehicle.

FIG. 3 is a diagram schematically illustrating a state in which the door open-close device for the vehicle according to an exemplary embodiment of the present disclosure is disposed on a door.

FIG. 4 is a diagram illustrating a main arm and a main arm motor of the door open-close device for the vehicle according to an exemplary embodiment of the present disclosure.

FIG. 5 is an exploded perspective view of the door open-close device for the vehicle according to an exemplary embodiment of the present disclosure.

FIG. 6 is a diagram schematically illustrating a door closing state of the door open-close device for the vehicle according to an exemplary embodiment of the present disclosure viewed from above.

FIG. 7 is a diagram schematically illustrating a door opening start state of the door open-close device for the vehicle according to an exemplary embodiment of the present disclosure viewed from above.

FIG. 8 is a diagram schematically illustrating a state, viewed from above, in which a door is opening due to a change in the length of a variable sub-arm after a door opening start of the door open-close device for the vehicle according to an exemplary embodiment of the present disclosure.

FIG. 9 is a diagram schematically illustrating a door opening completion state of the door open-close device for the vehicle according to an exemplary embodiment of the present disclosure viewed from above.

FIG. 10 is a diagram illustrating a door closing state before the variable sub-arm of the door open-close device for the vehicle according to an exemplary embodiment of the present disclosure rotates along a first guide slit on a base plate.

FIG. 11 is a diagram illustrating a state in which a door is opened while the variable sub-arm of the door open-close device for the vehicle according to an exemplary embodiment of the present disclosure rotates along the first guide slit on the base plate.

FIG. 12 is a diagram illustrating the change in the length of the variable sub-arm during door opening of the door open-close device for the vehicle according to an exemplary embodiment of the present disclosure.

FIG. 13 is a diagram illustrating a state in which the door is completely opened as the variable sub-arm of the door open-close device for the vehicle according to an exemplary embodiment of the present disclosure rotates along the first guide slit on the base plate.

FIG. 14 is a diagram illustrating a movement path of an internal end portion of the door in a door opening process of the door open-close device for the vehicle according to an exemplary embodiment of the present disclosure.

### DETAILED DESCRIPTION

The present disclosure will be described more fully hereinafter with reference to the accompanying drawings, so that those skilled in the art to which the present disclosure pertains may easily implement the exemplary embodiments of the present disclosure. However, the present disclosure may be implemented in various forms and is not limited to the exemplary embodiments described herein.

Furthermore, in various embodiments, elements having the same configuration are typically described in an embodiment by use of the same reference numerals, and in other exemplary embodiments of the present disclosure, only configurations different from an embodiment will be described.

Please be informed that the drawings are schematic and not drawn to scale. Relative dimensions and ratios of parts in the drawings are shown exaggerated or reduced in size for clarity and convenience in the drawings, and any dimensions are illustrative only and not limiting. Furthermore, the same reference numerals are used to denote similar features in the same structure, element or parts appearing in two or more drawings. When an element is referred to as being “on” another element, it may be directly on the other element or intervening elements may also be accompanied.

The embodiment of the present disclosure specifically represents an embodiment of the present disclosure. As a result, various modifications of diagrams are expected. Therefore, the embodiment is not limited to a specific shape of an area shown, and includes, for example, a modification of the shape by manufacturing.

Hereinafter, a door open-close device for a vehicle according to an exemplary embodiment of the present disclosure will be described in detail with reference to the accompanying drawings.

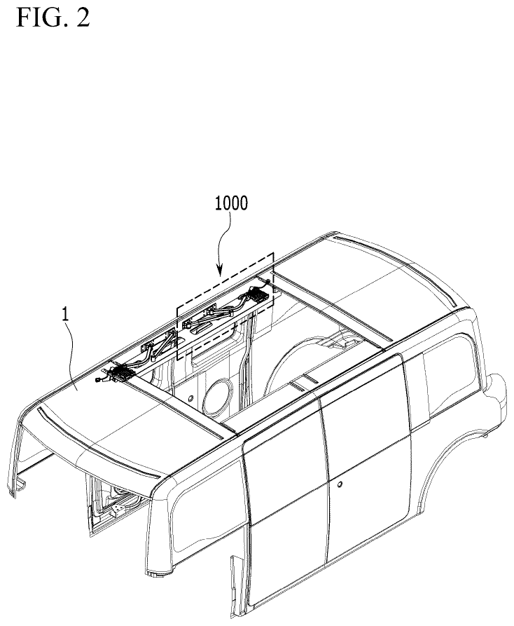

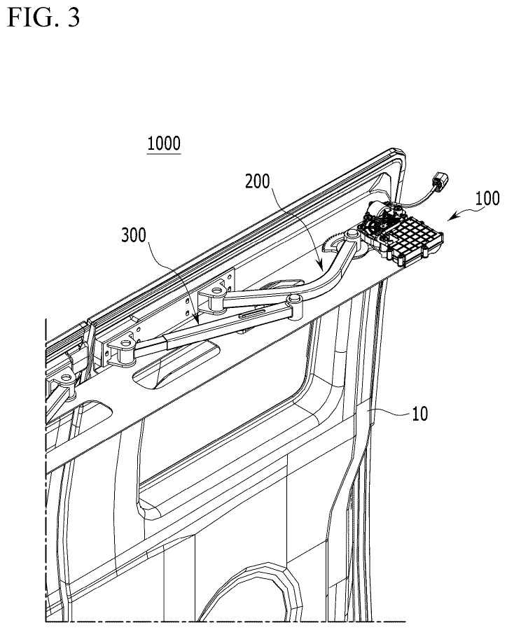

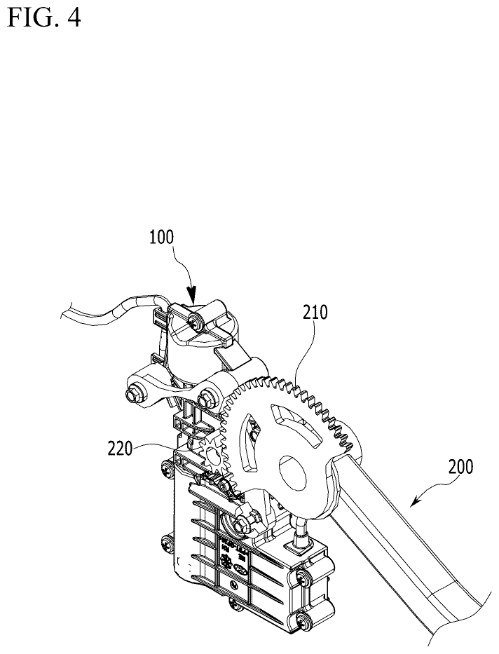

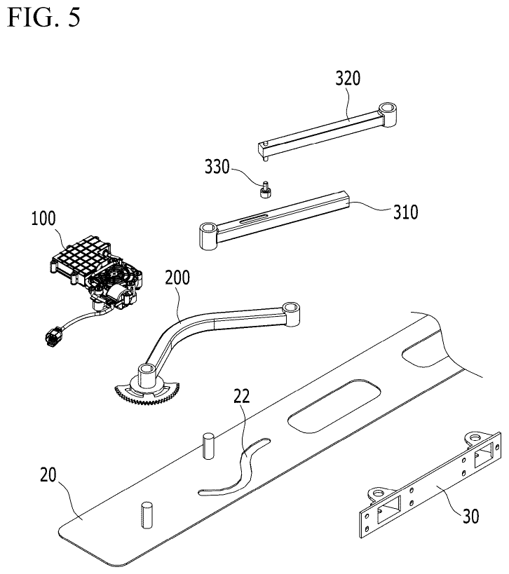

FIG. 2 is a diagram schematically illustrating a state in which a door open-close device for a vehicle according to an exemplary embodiment of the present disclosure is applied to the vehicle. FIG. 3 is a diagram schematically illustrating a state in which the door open-close device for the vehicle according to an exemplary embodiment of the present disclosure is disposed on a door. FIG. 4 is a diagram illustrating a main arm and a main arm motor of the door open-close device for the vehicle according to an exemplary embodiment of the present disclosure. FIG. 5 is an exploded perspective view of the door open-close device for the vehicle according to an exemplary embodiment of the present disclosure.

Referring to FIG. 2 and FIG. 3, a door open-close device 1000 for a vehicle according to an exemplary embodiment of the present disclosure is to open or close a door opening portion by sliding and popping up front and rear doors 10 formed on a vehicle body 1 and is disposed in an upper portion of the door opening portion of the vehicle body 1.

The door open-close device 1000 may be disposed in a pair to face each other on the upper portion of the door opening portion corresponding to the front and rear doors 10, respectively, and may be disposed to connect the outside of the vehicle body 1 and the inside of the front and rear doors 10.

Referring to FIG. 4 and FIG. 5, the vehicle door open-close device 1000 according to an exemplary embodiment of the present disclosure includes a main arm motor 100, a main arm 200, and a variable sub-arm 300.

The main arm motor 100 may be fixedly disposed on the side of the vehicle body 1 and may provide power to operate the door 10. The main arm motor 100 generates a driving force and transmits the driving force to the main arm 200. The main arm 200 has one end portion hingedly coupled to the main arm motor 100 and the other end portion hingedly coupled to the side of the door 10 so that the main arm 200 transmits a rotation force to the door 10 by driving the main arm motor 100.

As shown in FIG. 4, a main arm gear 210 may be disposed in one end portion of the main arm 200, and engaged with a main arm motor gear 220 formed on a rotation shaft of the main arm motor 100, so that the main arm 200 may be hingedly rotated when the main arm motor 100 is driven.

The variable sub-arm 300 may be disposed to be parallel to the main arm 200 in a longitudinal direction of the vehicle body 1, have one end portion hingedly coupled to the side of the vehicle body 1, the other end portion hingedly coupled to the side of the door 10, and when the door 10 is opened or closed, disposed to change the length thereof along a movement path of a rotation member which is disposed and rotated in one portion.

As shown in FIG. 5, the main arm 200 may be formed in a curved shape toward the interior of the vehicle body 1. A base plate 20, in which the main arm motor 100 is fixedly disposed and to which one end portion of the main arm 200 is hingedly coupled, and one end portion of the variable sub-arm 300 is hingedly coupled, may be disposed on the side of the vehicle body 1.

Furthermore, a door bracket 30 to which the other end portion of the main arm 200 and the other end portion of the variable sub-arm 300 are hingedly coupled and connecting the main arm 200 and the variable sub-arm 300 to the door 10, may be disposed inside the door 10.

Meanwhile, the variable sub-arm 300 may include a fixing sub-arm 310 and a slide sub-arm 320. The fixing sub-arm 310 has one end portion hingedly coupled to the side of the vehicle body 1 and includes a hollow 315 formed therein. One end portion of the fixing sub-arm 310 may be hingedly coupled to the base plate 20.

The slide sub-arm 320 may be slid and moved in a longitudinal direction of the fixing sub-arm 310 so that one end portion thereof is moved relative to the fixing sub-arm 310, and the other end portion thereof may be hingedly coupled to the side of the door 10. The other end portion of the slide sub-arm 320 may be hingedly coupled to the base plate 20.

The fixing sub-arm 310 may be formed in a hollow shape extending in the longitudinal direction, and the slide sub-arm 320 may operate to be inserted into or withdrawn from the hollow of the fixing sub-arm 310.

A guide bearing 330 is disposed in the slide sub-arm 320 in one end portion as a rotation member that protrudes to rotate, and a second guide slit 23 through which the guide bearing 330 is disposed to penetrate and defining a sliding movement range of the slide sub-arm 320 is formed in the fixing sub-arm 310.

A first guide slit 22 providing a path varying the length of the variable sub-arm 300 may be formed in the base plate 20. The guide bearing 330 in one end portion of the slide sub-arm 320 may penetrate the second guide slit 23 of the fixing sub-arm 310 and be inserted into the first guide slit 22 of the base plate 20. As the guide bearing 330 is inserted into the first guide slit 22 and rotates, an insertion depth into the hollow of the fixing sub-arm 310 of the slide sub-arm 320 is changed, and thus the length of the variable sub-arm 300 may be changed.

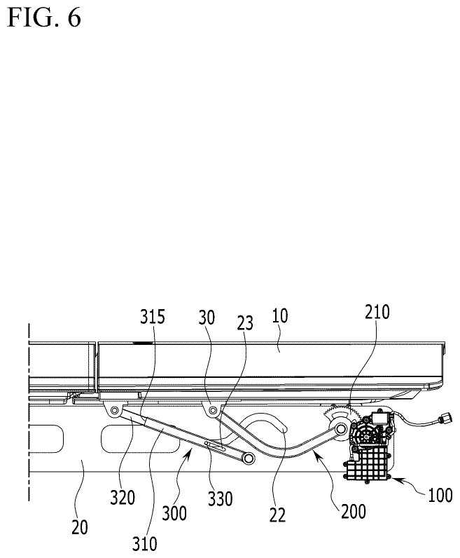

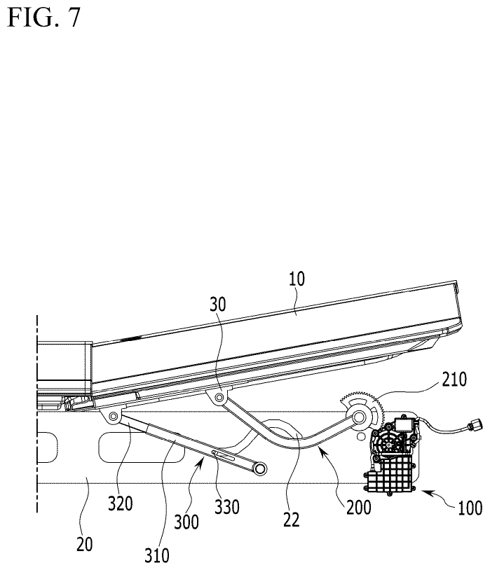

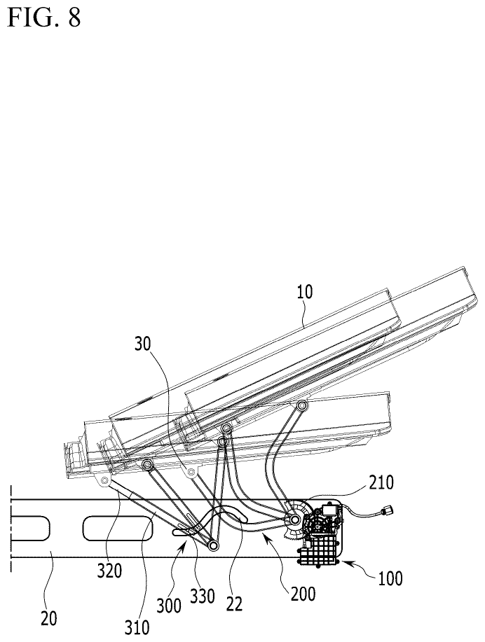

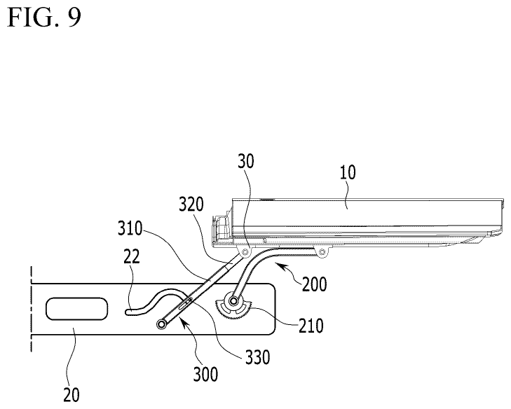

FIG. 6 is a diagram schematically illustrating a door closing state of the door open-close device for the vehicle according to an exemplary embodiment of the present disclosure viewed from above. FIG. 7 is a diagram schematically illustrating a door opening start state of the door open-close device for the vehicle according to an exemplary embodiment of the present disclosure viewed from above. FIG. 8 is a diagram schematically illustrating a state, viewed from above, in which a door is opening due to a change in the length of a variable sub-arm after a door opening start of the door open-close device for the vehicle according to an exemplary embodiment of the present disclosure. p FIG. 9 is a diagram schematically illustrating a door opening completion state of the door open-close device for the vehicle according to an exemplary embodiment of the present disclosure viewed from above.

Referring to FIG. 6, in a state in which the door 10 is closed, the door 10 is disposed parallel to the vehicle body 1, a central axis of the main arm gear 210 disposed in one end portion of the main arm 200 is rotatably connected to the base plate 20, and the other end portion of the main arm 200 is rotatably connected to the door bracket 30. Furthermore, one end portion of the variable sub-arm 300 is rotatably connected to the base plate 20, and the other end portion thereof is rotatably connected to the door bracket 30. At the instant time, the main arm motor 100 and the variable arm motor 330 are not driven.

Referring to FIG. 7, in a state in which the door 10 starts to be opened, when the main arm motor 100 is driven so that the main arm 200 starts to turn toward the outside of the vehicle body 1, a portion of the door bracket 30 connected to the other end portion of the main arm 200 starts to move toward the outside of the vehicle body 1. On the other hand, because the portion of the door bracket 30 to which the other end portion of the variable sub-arm 300 is connected is still positioned close to the base plate 20, the door 10 is disposed in an inclined form to protrude further from the side of the main arm 200 to the outside of the vehicle body 1 than from the side of the variable sub-arm 300.

Referring to FIG. 8, in a state in which the door 10 is opening, the main arm motor 100 continues to be driven so that the main arm 200 continues to turn toward the outside of the vehicle body 1, and the door bracket 30 turns toward the outside of the vehicle body 1 so that the variable sub-arm 300 connected to the door bracket 30 also turns. The variable sub-arm 300 includes a fixing sub-arm 310 and a slide sub-arm 320 inserted into a hollow 315 of the fixing sub-arm 310, and the fixing sub-arm 310 turns toward the outside of the vehicle body 1 with one end portion rotatably connected to the base plate 20. The guide bearing 330 disposed in one end portion of the slide sub-arm 320 is inserted into the second guide slit 23 formed in the fixing sub-arm 310 and the first guide slit 22 formed in the base plate 20, so that one end portion of the slide sub-arm 320 moves along the path of the second guide slit 23 and the path of the first guide slit 22.

In other words, because one end portion of the slide sub-arm 320 moves along the path of the first guide slit 22, and the fixing sub-arm 310 turns with a certain radius toward the outside of the vehicle body 1, an insertion depth of the slide sub-arm 320 changes in the hollow 315 of the fixing sub-arm 310, resulting in the length of the variable sub-arm 300 being expanded or contracted. The movement path of the slide sub-arm 320 and the corresponding change in the length of the variable sub-arm 300 may be adjusted by the shape of the first guide slit 22. The first guide slit 22 may be formed in a convex shape toward the side of the door 10.

On the other hand, although not shown, at least one sensor configured for detecting an obstacle may be disposed outside the door 10 and/or outside the vehicle body 1, and the driving of the main arm motor 100 may be stopped or the speed and amount of rotations of the main arm motor 100 may be adjusted according to whether there is the obstacle detected by the sensor. The control of the main arm motor 100 may be performed by a controller implemented in one or more processors operating by a set program.

Referring to FIG. 9, the main arm 200 is rotated by driving the main arm motor 100 until the opening of the door 10 is completed, and the variable arm motor 330 is driven so that the variable sub-arm 300 is shortened and then extended again, and thus the door 10 is finally disposed parallel to the vehicle body 1. At the instant time, in a state in which the opening of the door 10 is completed, the variable sub-arm 300 is extended to have the maximum length, and the main arm 200 is turned to the outside of the vehicle body 1 to the maximum.

The process of changing from a complete opening state to a complete closing state of the door 10 may be a reverse order of the process of FIG. 6, FIG. 7, FIG. 8, and FIG. 9.

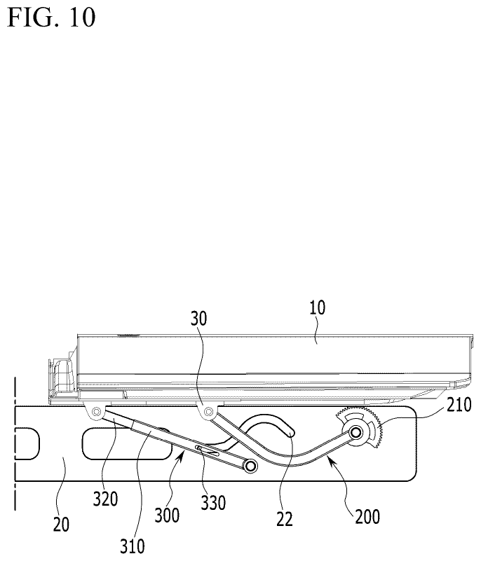

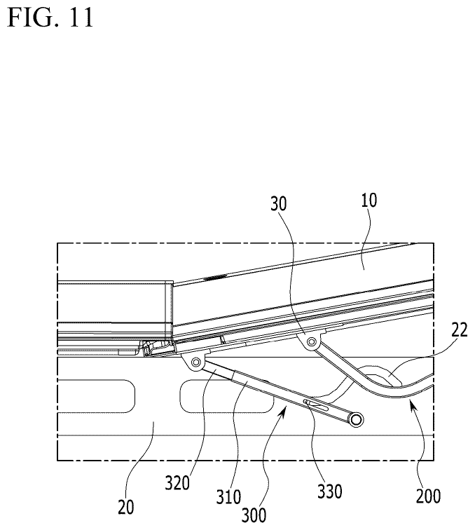

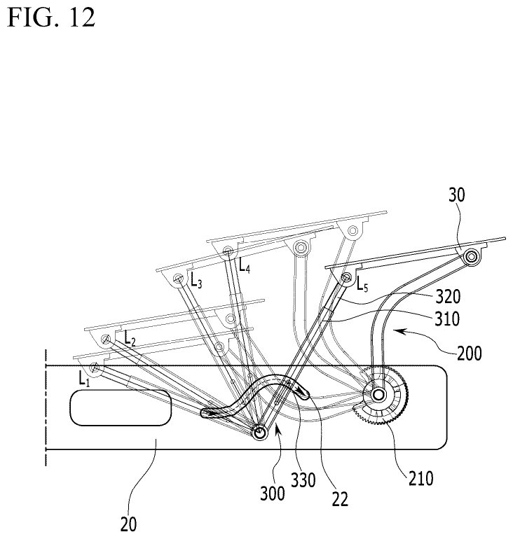

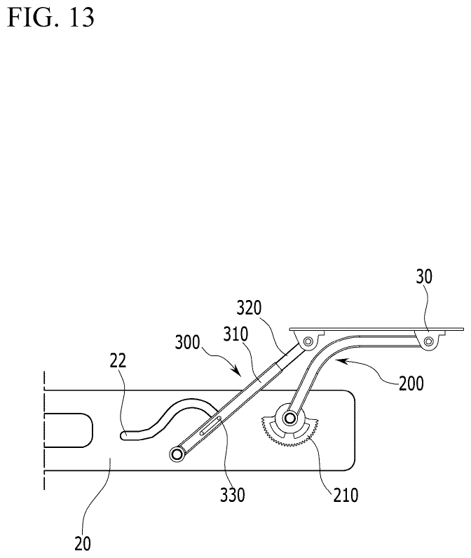

FIG. 10 is a diagram illustrating a door closing state before the variable sub-arm of the door open-close device for the vehicle according to an exemplary embodiment of the present disclosure rotates along a first guide slit 22 on a base plate. FIG. 11 is a diagram illustrating a state in which a door is opened while the variable sub-arm of the door open-close device for the vehicle according to an exemplary embodiment of the present disclosure rotates along the first guide slit 22 on the base plate. FIG. 12 is a diagram illustrating the change in the length of the variable sub-arm during door opening of the door open-close device for the vehicle according to an exemplary embodiment of the present disclosure. FIG. 13 is a diagram illustrating a state in which the door is completely opened as the variable sub-arm of the door open-close device for the vehicle according to an exemplary embodiment of the present disclosure rotates along the first guide slit 22 on the base plate.

As shown in FIG. 10, and FIG. 11, one end portion of the main arm 200 is hingedly coupled to the side of the vehicle body 1 and the other end portion thereof is hingedly coupled to the inside of the door 10. The variable sub-arm 300 is disposed in a position parallel to a longitudinal direction of the vehicle body 1, has one end portion hingedly coupled to the side of the vehicle body 1, and includes the other end portion hingedly coupled to the inside of the door 10.

The main arm 200 may be formed in a curved shape toward the interior of the vehicle body 1, and the variable sub-arm 300 may be formed in a straight shape. The hinge rotation of the main arm 200 is performed by driving the main arm motor 100, and the hinge rotation of the variable sub-arm 300 is hingedly rotated together according to the hinge rotation of the main arm 200.

The variable sub-arm 300 includes the fixing sub-arm 310 and the slide sub-arm 320, and the slide sub-arm 320 may reciprocate inside the hollow 315 of the fixing sub-arm 310 so that the variable sub-arm 300 may be expanded or contracted. The relative movement of the fixing sub-arm 310 and the slide sub-arm 320 may be adjusted by the guide bearing 330 disposed in one end portion of the slide sub-arm 320 being inserted into the first guide slit 22 formed in the base plate 20 and the second guide slit 23 of the fixing sub-arm 310 and moved.

While the fixing sub-arm 310 interacts with the turning of the main arm 200 and turns, one end portion of the slide sub-arm 320 moves along the path of the first guide slit 22, which changes the depth of the slide sub-arm 320 inserted into the hollow 315 of the fixing sub-arm 310. Therefore, while the door 10 is opened, the length of the variable sub-arm 300 may be expanded or contracted according to the path of the first guide slit 22.

Referring to FIG. 12, in a state in which the door 10 is closed, when the door 10 starts to be opened, the main arm motor 100 is driven so that the main arm 200 starts to turn toward the outside of the vehicle body 1. At the instant time, one end portion of the slide sub-arm 320 of the variable sub-arm 300 moves along the first guide slit 22 and moves to be inserted to a hollow 315 inside of the fixing sub-arm 310 so that the length of the variable sub-arm 300 is shortened (L₁).

Thereafter, when the main arm 200 turns further toward the outside of the vehicle body 1, one end portion of the slide sub arm 320 of the variable sub arm 300 moves along the first guide slit 22 and moves to be withdrawn from the hollow 315 inside of the fixing sub-arm 310 so that the length of the variable sub-arm 300 is gradually extended (L₂, L₃, and L₄).

Thereafter, when the main arm 200 turns further toward the outside of the vehicle body 1, one end portion of the slide sub-arm 320 of the variable sub-arm 300 moves along the first guide slit 22, and one end portion of the slide sub arm 320 turns with a certain radius along the path of the first guide slit 22. At the instant time, the fixing sub-arm 310 continues to turn, and as a result, the length of the variable sub-arm 300 starts to be shortened (L₅).

Referring to FIG. 13, when the opening of the door 10 is completed, the door 10 is disposed parallel to the vehicle body 1, and the slide sub-arm 320 is inserted and moved toward the hollow inside of the fixing sub-arm 310 so that the variable sub-arm 300 is shortened to the maximum. The main arm motor 100 may be set to stop driving when the opening of the door 10 is completed. Furthermore, the main arm motor 100 may have a preset number of rotations to adjust a movement range of the main arm 200 and an amount of opening of the door 10 according to the number of rotations.

When the door 10 is opened to the maximum, the main arm 200 is turned to the outside of the vehicle body 1 to the maximum, and an opening width of the door 10 is also as large as possible.

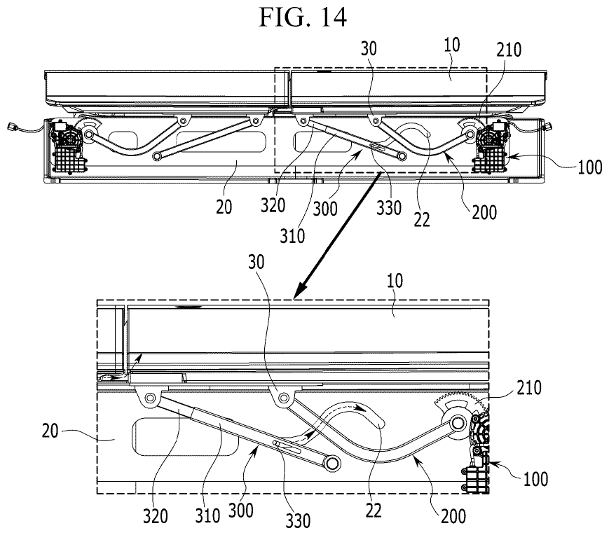

FIG. 14 is a diagram illustrating a movement path of an internal end portion of the door in a door opening process of the door open-close device for the vehicle according to an exemplary embodiment of the present disclosure.

Referring to FIG. 14, the first guide slit 22 formed in the base plate 20 is formed in a convex shape toward the door 10, and the guide bearing 330 disposed in one end portion of the slide sub-arm 320 is moved when the door 10 is opened while being inserted into the first guide slit 22. The other end portion of the slide sub-arm 320 is rotatably connected to the door bracket 30, and the door bracket 30 moves as the other end portion of the main arm 200 turns, and thus the other end portion of the slide sub-arm 320 also moves.

During a process of opening the door 10, the side of the door bracket 30 connected to the other end portion of the slide sub-arm 320, that is, an internal end portion of the door 10, is moved to have a similar path to the shape of the first guide slit 22 which is a path through which the guide bearing 330 moves. Therefore, when the guide bearing 330 is in a position where the first guide slit 22 is formed closest to the side of the door 10, the internal end portion of the door 10 protrudes the farthest outside the vehicle body 1. Furthermore, when the door 10 is completely opened, the guide bearing 330 is positioned in an end portion where the first guide slit 22 is bent toward the interior of the vehicle body 1, and the internal end portion of the door 10 also moves toward the interior of the vehicle body 1, and the door 10 is finally disposed parallel to the vehicle body 1.

According to an exemplary embodiment of the present disclosure, the variable door arm structure is applied in the counter sliding door structure of the vehicle without a B-pillar, and thus, the door rotation radius may be minimized, minimizing the amount of protrusion toward the outside of the vehicle body of the door when the door is opened.

Furthermore, an interference avoidance operation between the front and rear doors is possible, which enables the door open-close operation regardless of the order of the front and rear doors, and sealing damage and jamming according to the order of door operations may be prevented.

Furthermore, a center rail structure is deleted, and thus, the door opening width may be maximized, and cost reduction, assembly, and maintainability may be improved due to the simplification of the structure.

Although exemplary embodiments of the present disclosure have been described above, the present disclosure is not limited to the above embodiments, the present disclosure includes all modifications within the range easily changed and recognized as being equivalent by those of ordinary skill in the art to which the present disclosure pertains from the embodiments of the present disclosure.

### DESCRIPTION OF SYMBOLS

1000: door open-close device for vehicle
1: vehicle body
10: door
20: base plate
22: first guide slit
23: second guide slit
30: door bracket
100: main arm motor
200: main arm
210: main arm gear
300: variable sub-arm
310: fixing sub-arm
320: slide sub-arm
330: guide bearing

What is claimed is:

1. A door open-close device configured to open or close a door opening portion of a vehicle by sliding and popping up a door disposed in a vehicle body, the door open-close device comprising:
a main arm motor fixedly disposed on a side of the vehicle body and configured to provide a driving power to operate the door;
a main arm including a first end portion hingedly coupled to the main arm motor and a second end portion hingedly coupled to a side of the door and configured to transmit a rotation force to the door by receiving the driving power from the main arm motor; and
a variable sub-arm including a first end portion hingedly coupled to the side of the vehicle body, and a second end portion hingedly coupled to the side of the door, and, for opening or closing the door, disposed to change a length of the variable sub-arm along a movement path of a rotation member which is disposed and rotated in a portion of the variable sub-arm.

2. The door open-close device of claim 1, wherein a main arm gear is disposed in the first end portion of the main arm, and engaged with a main arm motor gear formed on a rotation shaft of the main arm motor, so that the main arm is hingedly rotated based on that the main arm motor is driven.

3. The door open-close device of claim 1, wherein the main arm is formed in a curved shape toward an interior of the vehicle body.

4. The door open-close device of claim 3, wherein the second end portion of the main arm is in a shape bent to be in parallel to the door when the door is opened.

5. The door open-close device of claim 1, wherein the variable sub-arm includes at least two sub-arms slidably engaged to each other.

6. The door open-close device of claim 5, wherein the at least two sub-arms of the variable sub-arm include:
a fixing sub-arm including a first end portion hingedly coupled to the side of the vehicle body and a hollow formed in the fixing sub-arm; and
a slide sub-arm engaged to the fixing sub-arm and configured to slide and move in a longitudinal direction of the fixing sub-arm so that a first end portion of the slide sub-arm is movable relative to the fixing sub-arm, and a second end portion of the slide sub-arm is hingedly coupled to the side of the door.

7. The door open-close device of claim 6,
wherein the hollow of the fixing sub-arm extends in the longitudinal direction of the fixing sub-arm, and
wherein the slide sub-arm is configured to operate to be inserted into or withdrawn from the hollow of the fixing sub-arm.

8. The door open-close device of claim 7, further comprising:
a guide bearing slidably engaged to the fixing sub-arm in the first end portion of the fixing sub-arm as a rotation member that protrudes to rotate; and
a first guide slit through which the guide bearing is disposed to penetrate, wherein the first guide slit defines a sliding movement range of the slide sub-arm.

9. The door open-close device of claim 8,
wherein a base plate including the first guide slot is disposed on the side of the vehicle body.

10. The door open-close device of claim 8, further comprising:
a second guide slit disposed in the fixing sub-arm,
wherein the guide bearing is engaged to the first guide slit and the second guide slit.

11. The door open-close device of claim 1,
wherein a base plate in which the main arm motor is fixedly disposed and to which the first end portion of the main arm is hingedly coupled, and the first end portion of the variable sub-arm is hingedly coupled, is disposed on the side of the vehicle body.

12. The door open-close device of claim 11, wherein the base plate includes a first guide slit into which the guide bearing is disposed, the first guide slit providing a path varying the length of the variable sub-arm.

13. The door open-close device of claim 12, wherein the first guide slit is formed in a convex shape toward the side of the door.

14. The door open-close device of claim 1, wherein a door bracket to which the second end portion of the main arm and the second end portion of the variable sub-arm are hingedly coupled and connecting the main arm and the variable sub-arm to the door is disposed inside the door.

15. The door open-close device of claim 1,
wherein the door includes front and rear doors, and
wherein, when opening of the door starts,
the main arm motor is driven to rotate the first end portion of the main arm, and
the variable sub-arm is changed to shorten the length of the variable sub-arm so that overlapping between the front and rear doors is prevented.

16. The door open-close device of claim 15, wherein
during opening of the door, after passing through an overlapping prevention period between the front and rear doors,
the variable sub-arm is changed to extend the length of the variable sub-arm.

17. The door open-close device of claim 16, wherein the main arm motor is set to stop driving based on that the door is completely opened.

18. The door open-close device of claim 17, wherein the main arm motor has a preset number of rotations to adjust a movement range of the main arm and an amount of opening of the door according to the number of rotations.

19. The door open-close device of claim 18, wherein, during a process of opening the door, an internal end portion of the door moves to have a similar movement path to a shape of a first guide slit.

20. A vehicle comprising the door open-close device of claim 1.
